(19) United States
(12) Patent Application Publication
(10) Pub. No.: US 2026/0319095 A1
(43) Pub. Date: Oct. 15, 2026

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Yuya MATSUMOTO, Tokyo (JP)

(73) Assignee: NEC Corporation, Tokyo (JP)

(21) Appl. No.: 19/466,691

(22) Filed: Feb. 2, 2026

(30) Foreign Application Priority Data
Mar. 5, 2025 (JP) 2025-034813

(51) Int. Cl. G01S 17/89; G01S 17/42; G06T 7/246; G06T 7/73

(52) U.S. Cl. CPC G01S 17/89; G01S 17/42; G06T 7/248; G06T 7/74; G06T 2207/10028; G06T 2210/12

(57) ABSTRACT

An information processing apparatus includes: an acquisition unit for acquiring point cloud information from a setting range of a second frame measured at a second time point based on a setting range set for a target object located in a first frame measured at a first time point; a detection unit for detecting second point cloud information relevant to first point cloud information from the point cloud information of the setting range using the first point cloud information relevant to a first bounding box; a generation unit for generating conversion information for transferring the first point cloud information to the second point cloud information using each relevant point thereof; and an update unit for converting the first bounding box into a second bounding box using the conversion information, assigning the second bounding box to the target object moved in the second frame, and updating the second bounding box.

### CROSS REFERENCE TO RELATED APPLICATION

This application is based upon and claims the benefit of priority from Japanese patent application No. 2025-034813, filed on Mar. 5, 2025, the disclosure of which is incorporated herein in its entirety by reference.

### TECHNICAL FIELD

The present disclosure relates to an information processing apparatus, an information processing method, and a computer-readable recording medium for tracking movement of an object.

### BACKGROUND ART

Three-dimensional (3D) object detection is a task of detecting a bounding box assigned to point cloud information relevant to an object on a frame. Since a learning model is used in the 3D object detection, it is necessary to train the learning model. However, in a present situation, work of assigning a bounding box (label) to the point cloud information relevant to the object is manually executed.

As a related technique, PTL 1 (JP 2023-127389 A) discloses an information processing apparatus capable of improving accuracy of video analysis. An information processing apparatus disclosed in JP 2023-127389 A estimates direction information that is information indicating a change direction of a relative position between an imaging apparatus and a target object from a still image obtained by imaging the target object by the imaging apparatus, and generates a pseudo moving image including a change in the relative position between the imaging apparatus and the target object based on the estimated direction information and a target region that is a region including a target region that is a region relevant to the target object in the still image.

However, in JP 2023-127389 A, only a position of a target frame in a frame is moved in a direction of a specific vector indicating a feature of an optical flow and a direction opposite to the direction, and a bounding box (label) assigned to an object image is not automatically moved (tracked) by an amount in which the object has moved.

### SUMMARY

An object of the present disclosure is to automatically move (track) a bounding box (label) assigned to point cloud information relevant to an object by an amount in which the object has moved.

In order to achieve the above object, an information processing apparatus according to an aspect of the present disclosure includes:
an acquisition unit for acquiring point cloud information from a setting range of a second frame measured at a second time point later than a first time point based on a setting range set in advance around a first bounding box assigned to a target object located in a first frame measured at the first time point;
a detection unit for detecting second point cloud information relevant to first point cloud information from the point cloud information of the setting range using the first point cloud information relevant to the first bounding box;
a generation unit for generating conversion information for transferring the first point cloud information to the second point cloud information using each relevant point of the first point cloud information and the second point cloud information; and
an update unit for converting the first bounding box into a second bounding box using the conversion information, assigning the second bounding box to the target object moved in the second frame, and updating the second bounding box.

In order to achieve the above object, an information processing method according to another aspect of the present disclosure causes a computer to execute:
acquiring point cloud information from a setting range of a second frame measured at a second time point later than a first time point based on a setting range set in advance around a first bounding box assigned to a target object located in a first frame measured at the first time point;
detecting second point cloud information relevant to first point cloud information from the point cloud information of the setting range using the first point cloud information relevant to the first bounding box; generating conversion information for transferring the first point cloud information to the second point cloud information using each relevant point of the first point cloud information and the second point cloud information; and
converting the first bounding box into a second bounding box using the conversion information, assigning the second bounding box to the target object moved in the second frame, and updating the second bounding box.

Furthermore, in order to achieve the above object, a computer-readable recording medium according to still another aspect of the present disclosure program causes a computer to execute:
acquiring point cloud information from a setting range of a second frame measured at a second time point later than a first time point based on a setting range set in advance around a first bounding box assigned to a target object located in a first frame measured at the first time point;
detecting second point cloud information relevant to first point cloud information from the point cloud information of the setting range using the first point cloud information relevant to the first bounding box;
generating conversion information for transferring the first point cloud information to the second point cloud information using each relevant point of the first point cloud information and the second point cloud information; and
converting the first bounding box into a second bounding box using the conversion information, assigning the second bounding box to the target object moved in the second frame, and updating the second bounding box.

As described above, according to the present disclosure, the bounding box (label) assigned to the point cloud information relevant to the object can be automatically moved (tracked) by the amount in which the object has moved.

### BRIEF DESCRIPTION OF THE DRAWINGS

FIG. 1 is a diagram illustrating an example of an information processing apparatus;

FIG. 2 is a diagram illustrating a bounding box (label information);

FIG. 3 is a diagram illustrating an example of a system including the information processing apparatus;

FIG. 4 is a top view illustrating an example of a setting range;

FIG. 5 is a diagram illustrating an example of an operation of the information processing apparatus;

FIG. 6 is a diagram for describing Modification 2; and

FIG. 7 is a diagram illustrating an example of a computer that functions as the information processing apparatus according to an example embodiment, Modification 1, and Modification 2.

### EXAMPLE EMBODIMENT

Hereinafter, an example embodiment will be described with reference to drawings. In the drawings described below, elements having the same function or matching functions are denoted by the same reference sign, and repeated description thereof may be omitted.

### Example Embodiment

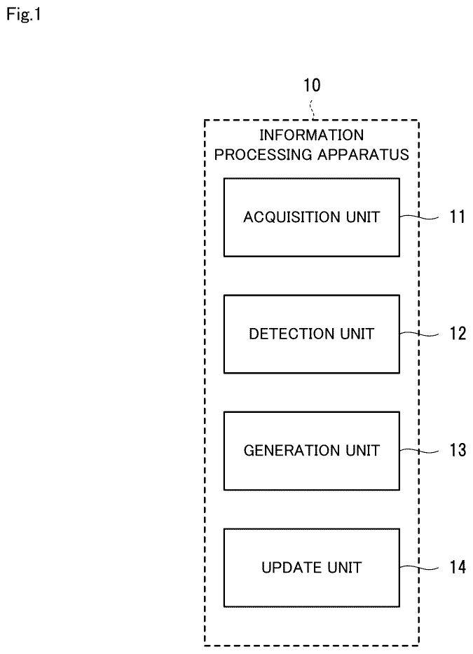

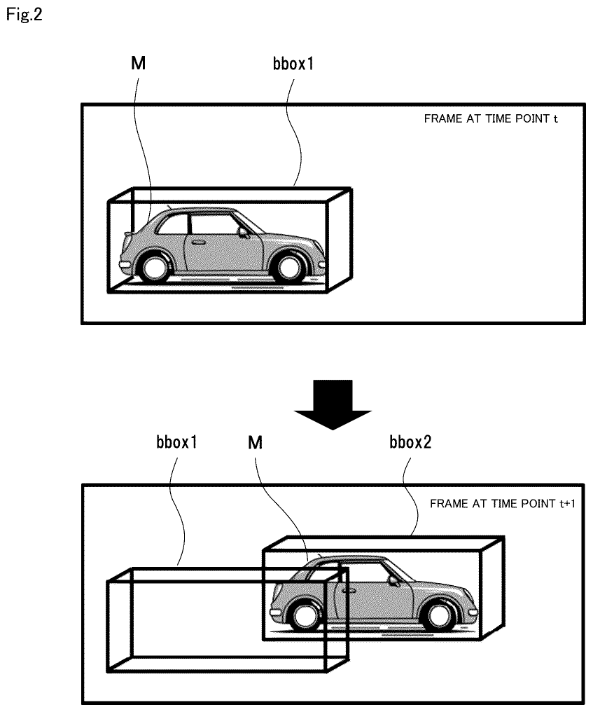

A configuration of an information processing apparatus according to the example embodiment will be described with reference to FIGS. 1 and 2. FIG. 1 is a diagram illustrating an example of the information processing apparatus. FIG. 2 is a diagram illustrating a bounding box.

### [Apparatus Configuration]

The information processing apparatus illustrated in FIG. 1 is an apparatus (label automatic tracking apparatus) that automatically moves (tracks) a bounding box (label) assigned to point cloud information relevant to an object by an amount in which the object has moved. As illustrated in FIG. 1, the information processing apparatus 10 includes an acquisition unit 11 (acquisition means), a detection unit 12 (detection means), a generation unit 13 (generation means), and an update unit 14 (update means).

The acquisition unit 11 acquires the point cloud information from a setting range of a second frame measured at a second time point later than a first time point based on a setting range set in advance around a first bounding box (first label information) assigned to a target object located in a first frame (point cloud information) measured at the first time point.

The detection unit 12 detects second point cloud information relevant to first point cloud information from the point cloud information of the setting range using the first point cloud information relevant to the first bounding box.

The generation unit 13 generates conversion information for transferring the first point cloud information to the second point cloud information using each relevant point of the first point cloud information and the second point cloud information.

The update unit 14 converts the first bounding box into a second bounding box (second label information) using the conversion information, assigns the second bounding box to the target object moved in the second frame, and updates the second bounding box.

In this way, according to the example embodiment, by assigning the second bounding box (second label information) to the target object moved in the second frame, the bounding box can be automatically moved (tracked) by an amount in which the object has moved.

Specifically, as illustrated in FIG. 2, a second bounding box bbox2 generated using a first bounding box bbox1 assigned to a target object M (for example, a vehicle) at a time point t is automatically assigned to the target object M (vehicle) moved at a time point t+1.

In the example of FIG. 2, the target object M and bounding boxes bbox at the first time point t and the second time point t+1 have been described. However, even after a third time point t+2, similarly, the bounding box may be automatically assigned to the target object M (vehicle) having moved.

Accordingly, in generation of learning data used for learning of a machine learning model that executes 3D object detection, labeling work that was being manually executed on a point cloud can be automated. Therefore, the labeling work can be reduced. Since there are usually a large number of objects in a frame, the labeling work can be dramatically reduced in such a case.

### [System Configuration]

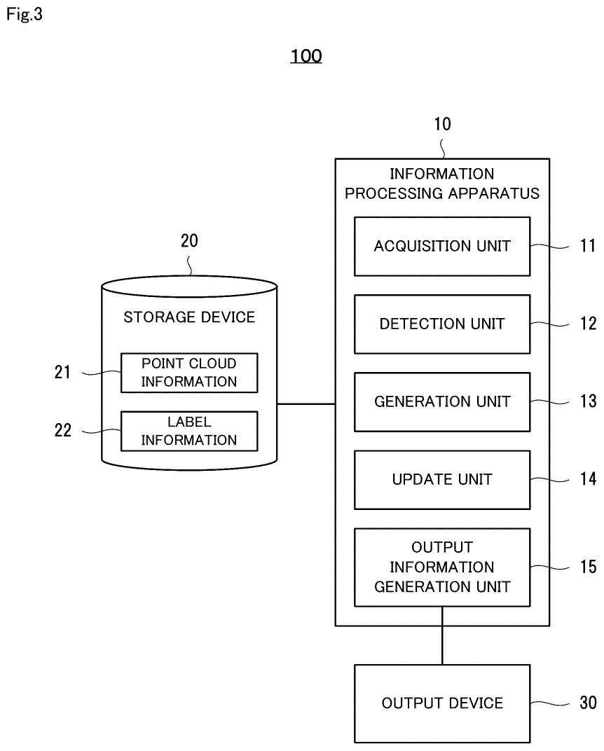

Next, a configuration of the information processing apparatus 10 according to the example embodiment will be described more specifically with reference to FIG. 3. FIG. 3 is a diagram illustrating an example of a system including the information processing apparatus.

As illustrated in FIG. 3, a system 100 according to the example embodiment includes the information processing apparatus 10, a storage device 20, and an output device 30. The information processing apparatus 10, the storage device 20, and the output device 30 are connected via a network.

The network is, for example, a general network constructed using a communication line such as the Internet, a local area network (LAN), a dedicated line, a telephone line, an inhouse network, a mobile communication network, Bluetooth (registered trademark), and wireless fidelity (Wi-Fi) (registered trademark).

The information processing apparatus 10 is, for example, an information processing apparatus such as a central processing unit (CPU), a programmable device such as a field-programmable gate array (FPGA), a graphics processing unit (GPU), or a circuit, a server computer, a personal computer, or a mobile terminal equipped with at least one of these.

The storage device 20 is a database, a server computer, a circuit including a memory, or the like. The storage device 20 stores, for example, at least information such as point cloud information 21 and label information 22. In the example of FIG. 3, the storage device 20 is provided outside of the information processing apparatus 10, but may be provided inside the information processing apparatus 10.

The output device 30 acquires output information converted into a format that can be output, as will be described below, and outputs a generated image, sound, and the like based on the output information. The output device 30 is, for example, an image display device using liquid crystal, organic electro luminescence (EL), or a cathode ray tube (CRT). Further, the image display device may include, for example, an audio output device such as a speaker. The output device 30 may be a printing device such as a printer.
The information processing apparatus will be described in detail.

The information processing apparatus 10 includes the acquisition unit 11, the detection unit 12, the generation unit 13, the update unit 14, and an output information generation unit 15.

The acquisition unit 11 first acquires point cloud information relevant to the first frame at the first time point from the point cloud information 21 stored in the storage device 20. The acquisition unit 11 acquires point cloud information relevant to the second frame at the second time point from the point cloud information 21 stored in the storage device 20. Furthermore, the acquisition unit 11 determines a first target object from one or more objects located in the frame at the first time point.

Subsequently, the acquisition unit 11 acquires label information relevant to the first bounding box assigned to a current target object at the first time point from the label information 22 stored in the storage device 20.

Here, a bounding box is assigned (labeled) to one or more target objects located in the first frame measured at the first time point. However, in the case of assigning the first bounding box (label), the bounding box is manually assigned (labeled) to the target object using a user interface.

The point cloud information is, for example, information measured in time series for each predetermined time (time point) using a measuring instrument such as LiDAR (Light Detection and Ranging, Laser Imaging Detection and Ranging).

The label information is information regarding the bounding box surrounding the target object. The label information (bounding box) is assigned to N objects in the frame. The bounding box at the first time point t (starting point) is expressed as in Math. 1.

$$bbox 1 = {\{ {bbox}_{i}^{t} \}}_{i = 1}^{N} \qquad [ Math . 1 ]$$

bbox1: Bounding box
t: Sampling time (time point)
i Number assigned to object in frame
N: Number of objects in frame

The point cloud in the bounding box can be expressed as in Math. 2.

$${\{ {P}_{i}^{t} \}}_{i = 1}^{N} : set of points ( point cloud ) that are within an i - th bounding box \qquad [ Math . 2 ]$$

Specifically, label information indicating a bounding box includes at least information such as a class name (object type such as vehicle), identification information (information for identifying an object), a center position (three-dimensional coordinates) of the object, a size (width l, depth w, height h), and a rotation angle θ (orientation of the object: rotation angle (yaw angle) on an xy plane).

Subsequently, the acquisition unit 11 sets a setting range (spatial range set in advance) around the first bounding box at the first time point. Subsequently, the acquisition unit 11 acquires the point cloud information from the setting range of the second frame measured at the second time point later than the first time point based on the setting range.

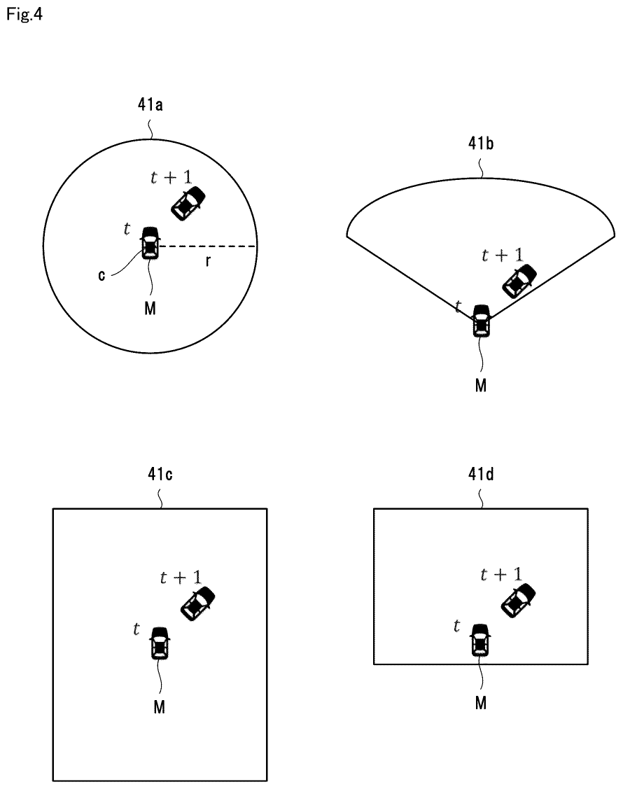

The setting range is, for example, a sphere, a hemisphere, a cylinder, or a polyhedron set with one point (coordinates) included in the target object at the first time point as a reference point. FIG. 4 is a top view illustrating an example of the setting range. In an example of 41a of FIG. 4, a cylindrical space having a radius r centered at the reference point of the target object M at the first time point t as a center c is set as the setting range. In an example of 41b of FIG. 4, a fan-shaped three-dimensional space extending from the reference point of the target object M at the first time point t to front of the target object M is set as the setting range. In an example of 41c of FIG. 4, a rectangular parallelepiped space including the reference point of the target object M at the first time point t is set as the setting range. In an example of 41d of FIG. 4, a rectangular parallelepiped space extending from the reference point of the target object M at the first time point t to the front of the target object M is set as the setting range.

In the example of FIG. 4, the acquisition unit 11 acquires the point cloud information located in a setting range 41 (41a, 41b, 41c, 41d) of the second frame measured at the second time point t+1. The point cloud of the setting range at the second time point t+1 can be expressed as in Math. 3.

$${\{ {Pr}_{i}^{t + 1} \}}_{i = 1}^{N} : Point cloud of setting range at second time point t + 1 \qquad [ Math . 3 ]$$

The detection unit 12 detects second point cloud information relevant to first point cloud information from the point cloud information of the setting range using the first point cloud information relevant to the first bounding box.

The generation unit 13 generates conversion information for transferring the first point cloud information to the second point cloud information using each relevant point of the first point cloud information and the second point cloud information.

Specifically, the detection unit 12 and the generation unit 13 generate conversion information for converting the first point cloud information at the first time point t into the second point cloud information at the second time point t+1 using processing such as iterative closest point (ICP).

Using the ICP processing, (1) the detection unit 12 detects a point cloud closest to the point cloud of the first bounding box from the points of the point cloud in the setting range. (2) The generation unit 13 generates conversion information Tᵢ=(Rᵢ, tᵢ) for transferring the first point cloud information to the second point cloud information using each relevant point of the first point cloud information and the second point cloud information. The second point cloud information at the second time point t+1 can be expressed as in Math. 4.

$${P}_{i}^{t + 1} = {R}_{i} {P}_{i}^{t} + {t}_{i} \qquad [ Math . 4 ]$$

Rᵢ: Three-dimensional rotation matrix for i-th object
tᵢ: three-dimensional translation vector with respect to i-th object

Subsequently, the update unit 14 converts the label information (first bounding box) at the first time point t into the label information (second bounding box) at the second time point t+1 using a transformation matrix T. Further, the bounding box bbox2 at the second time point t+1 is expressed as in Math. 5.

$$bbox 2 = {\{ {bbox}_{i}^{t + 1} \}}_{i = 1}^{N} \qquad [ Math . 5 ]$$

Specifically, when the bounding box is a cube, the update unit 14 converts each of points (three-dimensional coordinates) relevant to eight corners of the cube relevant to the first bounding box into the second bounding box using the transformation matrix T. The conversion of the eight points (three-dimensional coordinates) can be expressed as in Math. 6.

$${X}_{i}^{t + 1} = {R}_{i} {X}_{i}^{t} + {t}_{i} \qquad [ Math . 6 ]$$

Rᵢ: Three-dimensional rotation matrix for i-th object
tᵢ: Three-dimensional translation matrix for i-th object

$${X}_{i}^{t} : {X}_{i}^{t} = ( {x}_{1}^{t} , … , {x}_{8}^{t} ) ∈ {ℝ}^{3 \times 8} Eight corner points of cube representing bbox at time point t$$

$${X}_{i}^{t + 1} : {X}_{i}^{t + 1} = ( {x}_{1}^{t + 1} , … , {x}_{8}^{t + 1} ) ∈ {ℝ}^{3 \times 8} Eight corner points of cube representing bbox at time point t + 1$$

Subsequently, the update unit 14 converts eight points (three-dimensional coordinates) at the second time point t+1 into a format of label information. Thereafter, the update unit 14 assigns the second bounding box to the target object moved in the second frame and updates the second bounding box.

Further, when it is determined that the target object is out of a target frame at a time point later than the first time point based on a speed of the target object, the update unit 14 deletes the target object from a target. Specifically, when the update unit 14 updates an object position based on the speed of the target object and an object to be framed out (a target object that goes out of the range of the frame (three-dimensional space)) is detected, the update unit 14 deletes information regarding the target object and information regarding the bounding box of the target object.

The output information generation unit 15 generates output information for causing the output device 30 to display the target object and the bounding box as illustrated in FIG. 2, and outputs the generated output information to the output device 30. Thereafter, the output device 30 displays the target object and the bounding box.

As described above, even after the third time point t+2, similarly, a bounding box is generated using the point cloud information and the label information of a frame at a previous time point and the point cloud information and the label information of a frame at a current time point, and the generated bounding box is automatically assigned to the target object M (vehicle) having moved. Accordingly, as long as the bounding box serving as the first starting point can be set, the subsequent bounding boxes are automatically assigned to the target object M (vehicle).

### [Apparatus Operation]

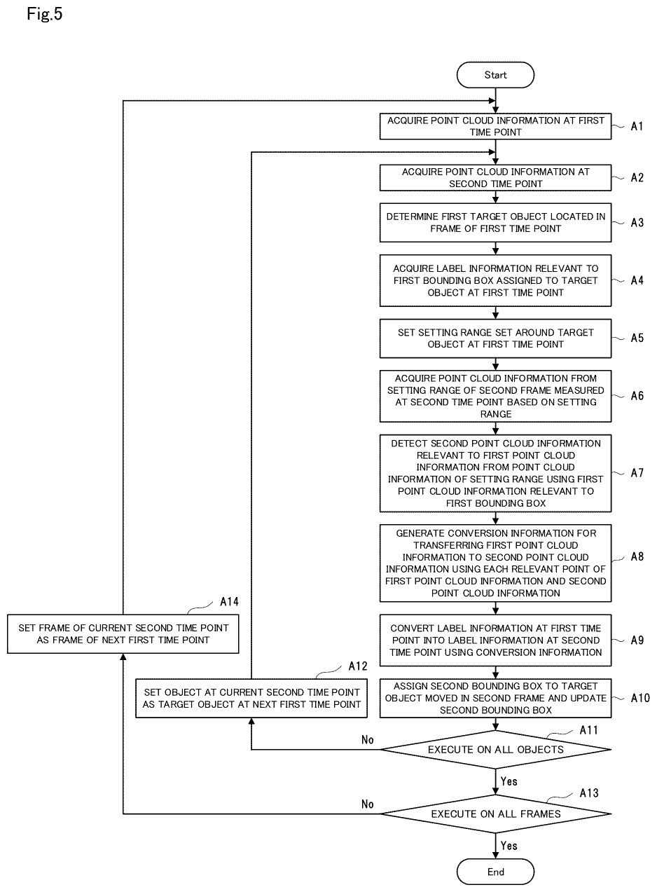

Next, an operation of the information processing apparatus according to the example embodiment will be described with reference to FIG. 5. FIG. 5 is a diagram illustrating an example of the operation of the information processing apparatus. The drawing will be appropriately referred to in the following description. In the example embodiment, by operating the information processing apparatus, an information processing method is executed. Accordingly, description of an information processing method according to the example embodiment is substituted with description of the operation of the information processing apparatus below.

As illustrated in FIG. 5, the acquisition unit 11 first acquires the point cloud information relevant to the first frame at the first time point from the point cloud information 21 stored in the storage device 20 (step A1). The acquisition unit 11 acquires the point cloud information relevant to the second frame at the second time point from the point cloud information 21 stored in the storage device 20 (step A2). Subsequently, the acquisition unit 11 determines the first target object from one or more objects located in the frame at the first time point (step A3).

Subsequently, the acquisition unit 11 acquires the label information relevant to the first bounding box assigned to the current target object at the first time point from the label information 22 stored in the storage device 20 (step A4).

Subsequently, the acquisition unit 11 sets a setting range (spatial range set in advance) around the first bounding box at the first time point (step A5). Subsequently, the acquisition unit 11 acquires the point cloud information from the setting range of the second frame measured at the second time point later than the first time point based on the setting range (step A6).

Subsequently, the detection unit 12 detects the second point cloud information relevant to the first point cloud information from the point cloud information of the setting range using the first point cloud information relevant to the first bounding box (step A7).

Subsequently, the generation unit 13 generates the conversion information for transferring the first point cloud information to the second point cloud information using each relevant point of the first point cloud information and the second point cloud information (step A8).

Specifically, in steps A7 and A8, the detection unit 12 and the generation unit 13 generate the conversion information for converting the first point cloud information at the first time point t into the second point cloud information at the second time point t+1 using processing such as iterative closest point (ICP).

However, when a moving speed of the target object is high, the generation unit 13 may execute a local feature point matching process between the first frame and the second frame using the first point cloud information and the second point cloud information, pair each relevant point, and then generate the conversion information by the ICP processing.

Subsequently, the update unit 14 converts the label information (first bounding box) at the first time point t into the label information (second bounding box) at the second time point t+1 using the conversion information (step A9).

Subsequently, the update unit 14 assigns the second bounding box to the target object moved in the second frame and updates the second bounding box (step A10).

Further, when it is determined that the target object is out of the target frame at a time point later than the first time point based on the speed of the target object, the update unit 14 deletes the target object from a target. Specifically, when the update unit 14 updates the object position based on the speed of the target object and the object to be framed out (a target object that goes out of the range of the frame (three-dimensional space)) is detected, the update unit 14 deletes the information regarding the target object and the information regarding the bounding box of the target object.

Subsequently, when the processing has not been executed on all the objects in the first frame (No in step A11), the object at the current second time point is set as the target object at the next first time point (step A12), the processing proceeds to step A2, and the processing of steps A2 to A10 is executed on the next target object.

When the processing has been executed for all the objects in the first frame (Yes in step A11), it is determined whether the processing has been executed for all the target frames (step A13).

When the processing has not been executed for all the target frames (No in step A13), the frame at the current second time point is set as the frame at the next first time point (step A14), the processing proceeds to step A1, and the processing of steps A1 to A11 is executed. When the processing has been executed for all the target frames (Yes in step A13), the processing ends.

### Effects of Example Embodiment

As described above, according to the example embodiment, by assigning the second bounding box (second label information) to the target object moved in the second frame, the bounding box can be automatically moved (tracked) by an amount in which the object has moved.

Specifically, the second bounding box bbox2 generated using the first bounding box bbox1 assigned to the target object M (for example, a vehicle) at the first time point t is automatically assigned to the target object M (vehicle) moved at the second time point t+1.

Although the target object M and the bounding box bbox at the first time point t and the second time point t+1 have been described, as described above, even after the third time point t+2, the bounding box may be automatically applied to the target object M (vehicle) having moved.

Accordingly, in the generation of the learning data used for the learning of the machine learning model that executes the 3D object detection, the labeling work that was being manually executed on the point cloud can be automated. Therefore, the labeling work can be reduced. Since there are usually a large number of objects in a frame, the labeling work can be dramatically reduced in such a case.

### [Program]

A program according to the example embodiment may be a program causing a computer to execute steps A1 to A14 illustrated in FIG. 5. When the program is installed and executed in the computer, the information processing apparatus and the information processing method according to the example embodiment can be achieved. In this case, a processor of the computer functions as the acquisition unit 11, the detection unit 12, the generation unit 13, the update unit 14, and the output information generation unit 15 and executes processing.

The program according to the example embodiment may be executed by a computer system constructed by a plurality of computers. In this case, for example, each computer may function as any of the acquisition unit 11, the detection unit 12, the generation unit 13, the update unit 14, and the output information generation unit 15.

### (Modification 1)

The above-described ICP processing is an algorithm on the assumption that a distance and an attitude of two point clouds are close to each other to some extent. Therefore, when the moving speed of the target object is high, a difference in distance and attitude between point clouds in the frames increases.

In this case, when the moving speed of the target object is high, the generation unit 13 executes the local feature point matching process between the first frame and the second frame using the first point cloud information and the second point cloud information, pairs each relevant point, and then generates the conversion information.

Specifically, the ICP processing accuracy may decrease, or the processing may not be executed correctly. Therefore, before the ICP processing, rough conversion from the point cloud of the frame at the first time point t to the point cloud of the frame at the second time point t+1 is executed by the local feature point matching process (see Reference Literature 1) or the like, the two point clouds are brought as close as possible, and then the ICP processing may be executed.
Reference Literature 1: Rusu, Radu Bogdan, Nico Blodow, and Michael Beetz. “Fast point feature histograms (FPFH) for 3D registration.” 2009 IEEE international conference on robotics and automation. IEEE, 12-17 May 2009.

### (Modification 2)

When the label information of the bounding box bbox relevant to two time points t and t−1 can be used, a distance between the point clouds is brought close using speed information instead of the local feature point matching.

In this case, when the moving speed of the target object is high (higher than a moving speed set in advance), the acquisition unit 11 calculates a speed using the first point cloud information, third point cloud information relevant to a third bounding box assigned to the target object M located in a third frame measured at a third time point t−1 before the first time point t, and a time difference between the first frame and the third frame.

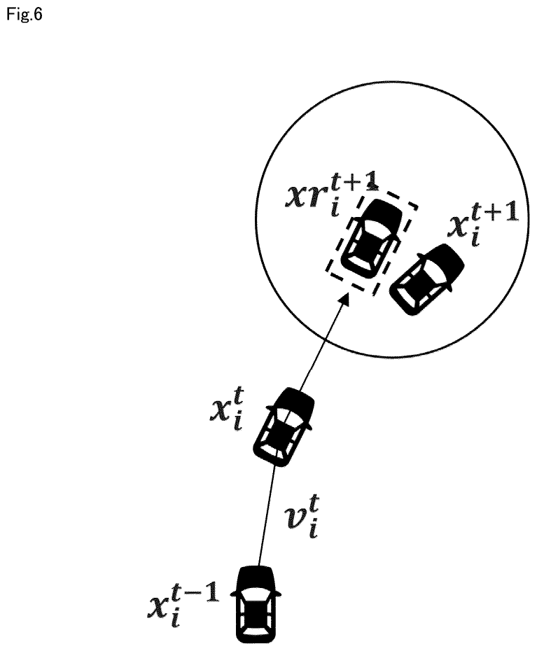

Description will be given with reference to FIG. 6. FIG. 6 is a diagram for describing Modification 2. Specifically, the moving speed of the target object is calculated using a moving distance from a point (three-dimensional coordinates) included in the third point cloud information to a point (three-dimensional coordinates) included in the first point cloud information and a difference in time stamps between these frames. In the example of FIG. 6, the moving distance from a center point of the third bounding box to the center point of the first bounding box is calculated, and the moving speed of the target object is calculated using a difference in moving distances and time stamps.

Subsequently, a position of the target object at the second time point t+1 is estimated using the calculated moving speed, a difference Δt in time stamps between the frames at the first time point t and the second time point t+1, and an orientation θ (yaw angle: rotation angle viewed from the z-axis) of the object. The estimated position can be expressed as in Math. 7.

$${xr}_{i}^{t + 1} = {x}_{i}^{t} + \vert {v}_{i}^{t} \vert Δ {t ( cos θ , sin θ , 0 )}^{T} \qquad [ Math . 7 ]$$

$${v}_{i}^{t} :$$

Moving speed
Δt: Difference in timestamps

Next, the acquisition unit 11 acquires the point cloud information based on the above-described setting range based on the estimated position (three-dimensional coordinates) of the target object M in the second frame.

### [Physical Configuration]

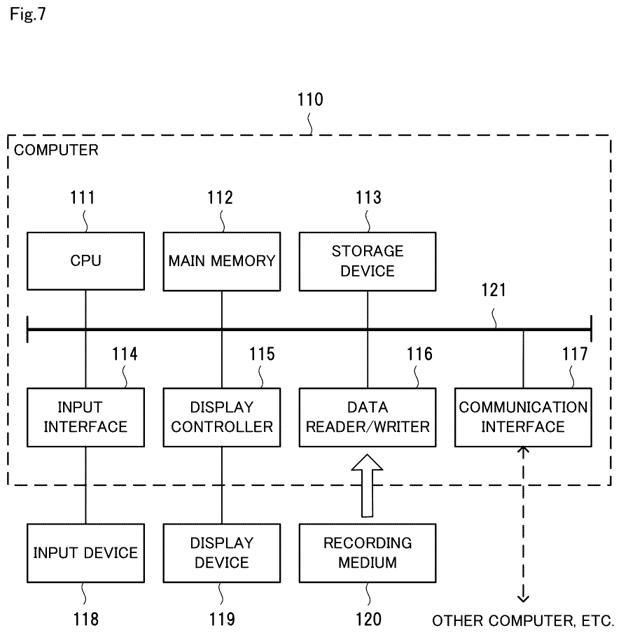

Here, a computer that functions as an information processing apparatus by executing a program in the example embodiment will be described with reference to FIG. 7. FIG. 7 is a diagram illustrating an example of the computer that functions as the information processing apparatus according to the example embodiment, Modification 1, and Modification 2.

As illustrated in FIG. 7, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to execute data communication with each other. The computer 110 may include a GPU or an FPGA in addition to the CPU 111 or instead of the CPU 111.

The CPU 111 loads the program in the example embodiment stored in the storage device 113 and configured by codes to the main memory 112, and executes the codes in a predetermined order to execute various computations. The main memory 112 is typically a volatile storage device such as a dynamic random access memory (DRAM).

The program in the example embodiment is provided in a state of being stored in a computer-readable recording medium 120. The program in the example embodiment may be distributed on the Internet connected via the communication interface 117.

Specific examples of the storage device 113 include a semiconductor storage device such as a flash memory, in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, reads the program from the recording medium 120, and writes a processing result in the computer 110 to the recording medium 120. The communication interface 117 mediates data transmission between the CPU 111 and another computer.

Specific examples of the recording medium 120 include a general-purpose semiconductor storage device such as a compact flash (CF) (registered trademark) or a secure digital (SD), a magnetic recording medium such as a flexible disk, and an optical recording medium such as a compact disk read only memory (CD-ROM).

The information processing apparatus 10 in the example embodiment can also be achieved using hardware relevant to each unit, for example, an electronic circuit, instead of a computer in which a program is installed. Moreover, a part of the information processing apparatus 10 may be achieved by a program, and the remaining part may be achieved by hardware. In the example embodiment, the computer is not limited to the computer illustrated in FIG. 7.

### [Supplementary Note]

With regard to the above example embodiments, the following supplementary notes are further disclosed. Some or all of the above-described example embodiments can be expressed by (Supplementary Note 1) to (Supplementary Note 12) to be described below, but are not limited to the following description.

### (Supplementary Note 1)

An information processing apparatus including:
an acquisition unit for acquiring point cloud information from a setting range of a second frame measured at a second time point later than a first time point based on a setting range set in advance around a first bounding box assigned to a target object located in a first frame measured at the first time point;
a detection unit for detecting second point cloud information relevant to first point cloud information from the point cloud information of the setting range using the first point cloud information relevant to the first bounding box;
a generation unit for generating conversion information for transferring the first point cloud information to the second point cloud information using each relevant point of the first point cloud information and the second point cloud information; and
an update unit for converting the first bounding box into a second bounding box using the conversion information, assigning the second bounding box to the target object moved in the second frame, and updating the second bounding box.

### (Supplementary Note 2)

The information processing apparatus according to Supplementary Note 1, wherein
when a moving speed of the target object is high, the generation unit executes a local feature point matching process between the first frame and the second frame using the first point cloud information and the second point cloud information, pairs each relevant point, and then generates the conversion information.

### (Supplementary Note 3)

The information processing apparatus according to Supplementary Note 1, wherein
the acquisition unit
   calculates a speed using the first point cloud information, third point cloud information relevant to a third bounding box assigned to the target object located in a third frame measured at a third time point earlier than the first time point, and a time difference between the first frame and the third frame, when the moving speed of the target object is high,
   calculates a position of the target object in the second frame using a time difference between the first frame and the second frame and a direction of the target object, and
   acquires the point cloud information of a preset setting range based on the calculated position of the target object in the second frame.

### (Supplementary Note 4)

The information processing apparatus according to Supplementary Note 1, wherein
when the target object is determined to be out of a frame at a time point later than the first time point based on the speed of the target object, the target object is deleted from a target.

### (Supplementary Note 5)

An information processing method causing a computer to execute:
acquiring point cloud information from a setting range of a second frame measured at a second time point later than a first time point based on a setting range set in advance around a first bounding box assigned to a target object located in a first frame measured at the first time point;
detecting second point cloud information relevant to first point cloud information from the point cloud information of the setting range using the first point cloud information relevant to the first bounding box;
generating conversion information for transferring the first point cloud information to the second point cloud information using each relevant point of the first point cloud information and the second point cloud information; and
converting the first bounding box into a second bounding box using the conversion information, assigning the second bounding box to the target object moved in the second frame, and updating the second bounding box.

### (Supplementary Note 6)

The information processing method according to Supplementary Note 5, wherein,
when a moving speed of the target object is high, the computer executes a local feature point matching process between the first frame and the second frame using the first point cloud information and the second point cloud information, pairs each relevant point, and then generates the conversion information.

### (Supplementary Note 7)

The information processing method according to Supplementary Note 5, wherein
the computer
   calculates a speed using the first point cloud information, third point cloud information relevant to a third bounding box assigned to the target object located in a third frame measured at a third time point earlier than the first time point, and a time difference between the first frame and the third frame when the moving speed of the target object is high,
   calculates a position of the target object in the second frame using a time difference between the first frame and the second frame and a direction of the target object, and
   acquires the point cloud information of a preset setting range based on the calculated position of the target object in the second frame.

### (Supplementary Note 8)

The information processing method according to Supplementary Note 5, wherein,
when the target object is determined to be out of a frame at a time point later than the first time point based on the speed of the target object, the target object is deleted from a target.

### (Supplementary Note 9)

A computer readable recording medium that includes a program recorded thereon, the program including instructions that causes a computer to carry out:
acquiring point cloud information from a setting range of a second frame measured at a second time point later than a first time point based on a setting range set in advance around a first bounding box assigned to a target object located in a first frame measured at the first time point;
detecting second point cloud information relevant to first point cloud information from the point cloud information of the setting range using the first point cloud information relevant to the first bounding box;
generating conversion information for transferring the first point cloud information to the second point cloud information using each relevant point of the first point cloud information and the second point cloud information; and
converting the first bounding box into a second bounding box using the conversion information, assigning the second bounding box to the target object moved in the second frame, and updating the second bounding box.

### (Supplementary Note 10)

The computer readable recording medium that includes the program according to Supplementary Note 9, wherein,
the program including instructions that causes the computer to carry out:
when a moving speed of the target object is high, a local feature point matching process between the first frame and the second frame using the first point cloud information and the second point cloud information, pair each relevant point, and then generate the conversion information.

### (Supplementary Note 11)

The computer readable recording medium that includes the program according to Supplementary Note 9, wherein
the program including instructions that causes the computer to carry out:
   calculating a speed using the first point cloud information, third point cloud information relevant to a third bounding box assigned to the target object located in a third frame measured at a third time point earlier than the first time point, and a time difference between the first frame and the third frame when the moving speed of the target object is high,
   calculating a position of the target object in the second frame using a time difference between the first frame and the second frame and a direction of the target object, and
   acquiring the point cloud information of a preset setting range based on the calculated position of the target object in the second frame.

### (Supplementary Note 12)

The computer readable recording medium that includes the program according to Supplementary Note 9, wherein,
the program including instructions that causes the computer to carry out:
when the target object is determined to be out of a frame at a time point later than the first time point based on the speed of the target object, the target object is deleted from a target.

While the invention has been particularly shown and described with reference to the example embodiment, the invention is not limited to the above-described example embodiment. It will be understood by those of ordinary skill in the art that various changes in form and details may be made therein without departing from the spirit and scope of the invention as defined by the claims.

### INDUSTRIAL APPLICABILITY

According to the above description, a bounding box (label) assigned to point cloud information relevant to an object can be automatically moved (tracked) by an amount in which the object has moved. It is useful in fields where tracking of objects is required.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. An information processing apparatus comprising:
at least one memory storing instructions; and
at least one processor configured to execute the instructions to:
acquire point cloud information from a setting range of a second frame measured at a second time point later than a first time point based on a setting range set in advance around a first bounding box assigned to a target object located in a first frame measured at the first time point;
detect second point cloud information relevant to first point cloud information from the point cloud information of the setting range using the first point cloud information relevant to the first bounding box;
generate conversion information for transferring the first point cloud information to the second point cloud information using each relevant point of the first point cloud information and the second point cloud information; and
convert the first bounding box into a second bounding box using the conversion information, assign the second bounding box to the target object moved in the second frame, and update the second bounding box.

2. The information processing apparatus according to claim 1, wherein,
the one or more processors further:
when a moving speed of the target object is high, executes a local feature point matching process between the first frame and the second frame using the first point cloud information and the second point cloud information, pairs each relevant point, and then generates the conversion information.

3. The information processing apparatus according to claim 1, wherein
the one or more processors further:
calculates a speed using the first point cloud information, third point cloud information relevant to a third bounding box assigned to the target object located in a third frame measured at a third time point earlier than the first time point, and a time difference between the first frame and the third frame when the moving speed of the target object is high,
calculates a position of the target object in the second frame using a time difference between the first frame and the second frame and a direction of the target object, and
acquires the point cloud information of a preset setting range based on the calculated position of the target object in the second frame.

4. The information processing apparatus according to claim 1, wherein,
the one or more processors further:
when the target object is determined to be out of a frame at a time point later than the first time point based on the speed of the target object, the target object is deleted from a target.

5. An information processing method causing a computer to execute:
acquiring point cloud information from a setting range of a second frame measured at a second time point later than a first time point based on a setting range set in advance around a first bounding box assigned to a target object located in a first frame measured at the first time point;
detecting second point cloud information relevant to first point cloud information from the point cloud information of the setting range using the first point cloud information relevant to the first bounding box;
generating conversion information for transferring the first point cloud information to the second point cloud information using each relevant point of the first point cloud information and the second point cloud information; and
converting the first bounding box into a second bounding box using the conversion information, assigning the second bounding box to the target object moved in the second frame, and updating the second bounding box.

6. A non-transitory computer readable recording medium that includes a program recorded thereon, the program including instructions that causes a computer to carry out:
acquiring point cloud information from a setting range of a second frame measured at a second time point later than a first time point based on a setting range set in advance around a first bounding box assigned to a target object located in a first frame measured at the first time point;
detecting second point cloud information relevant to first point cloud information from the point cloud information of the setting range using the first point cloud information relevant to the first bounding box;
generating conversion information for transferring the first point cloud information to the second point cloud information using each relevant point of the first point cloud information and the second point cloud information; and
converting the first bounding box into a second bounding box using the conversion information, assigning the second bounding box to the target object moved in the second frame, and updating the second bounding box.
